(19) United States
(12) Patent Application Publication
(10) Pub. No.: US 2013/0153744 A1
(43) Pub. Date: Jun. 20, 2013

(54) MOUNTING BRACKET FOR AIR CONDITIONER

(71) Applicants: Haibing Jin, Hangzhou (CN); Zhigang Gu, Hangzhou (CN); Jianjun Cao, Hangzhou (CN); Xudong Zhang, Hangzhou (CN)

(72) Inventors: Haibing Jin, Hangzhou (CN); Zhigang Gu, Hangzhou (CN); Jianjun Cao, Hangzhou (CN); Xudong Zhang, Hangzhou (CN)

(73) Assignee: Electrolux (Hangzhou) Domestic Appliances Co., Ltd., Hangzhou (CN)

(21) Appl. No.: 13/330,046

(22) Filed: Dec. 19, 2011

(51) Int. Cl. F16M 13/02

(52) U.S. Cl. 248/670; 248/675

(57) ABSTRACT

It is disclosed an mounting bracket for air conditioner including a supporting bottom bracket and a mounting standing bracket; wherein the mounting standing bracket includes a standing bracket fixing portion and a standing bracket sliding portion which are slidably connected with each other to form a frame structure, and the supporting bottom bracket is hinged with the standing bracket fixing portion. The mounting bracket further includes a connecting rod which is a telescopic rod with one end thereof connecting to the standing bracket fixing portion and the other end thereof connecting to the supporting bottom bracket. The air conditioner is supported by the supporting bottom bracket and is fixed by the mounting standing bracket into the mounting bracket, and then the mounting bracket is fixed on the window to support and fix the air conditioner.

### TECHNICAL FIELD OF THE INVENTION

The present disclosure relates to a technical field of air conditioner equipment, in particular to a mounting bracket for air conditioner.

### BACKGROUND OF THE INVENTION

The window air conditioner is an air conditioner mounted on the window and is very popular in Southeast Asia and North America as it can be easily mounted.

At present, a mounting bracket for mounting the window air conditioner can only support the air conditioner, but cannot install and fix the air conditioner. Thus for small air conditioners, due to the small size thereof the user usually installs the air conditioner on the window without using the mounting bracket, which cause the problem that the user needs to be very careful about the air conditioner when opening the window so as to prevent the air conditioner from falling off from the window.

For solving the above problems, an urgent problem to be solved by the person skilled in the art is to provide a mounting bracket which can not only support the air conditioner but also install the air conditioner stably on the window.

### SUMMARY OF THE INVENTION

The technical problem to be solved by the present disclosure is to provide a mounting bracket for air conditioner which can not only support the air conditioner but also can install the air conditioner stably on the window.

For solving the above problem, it is provided a mounting bracket for air conditioner including a supporting bottom bracket and a mounting standing bracket; wherein the mounting standing bracket includes a standing bracket fixing portion and a standing bracket sliding portion which are slidably connected with each other to form a frame structure for an window air conditioner, and the supporting bottom bracket is connected to the standing bracket fixing portion.

Preferably, the mounting bracket for air conditioner further includes a connecting rod which is a telescopic rod with one end thereof connecting to the standing bracket fixing portion and the other end thereof connecting to the supporting bottom bracket.

Preferably, the connecting rod is a two-stage telescopic rod including a first connecting rod and a second connecting rod which are slidably connected.

Preferably, a sliding hole is provided in the first connecting rod along the lengthwise direction thereof; a fixing component for slidably fitting with the sliding hole is provided on the second connecting rod.

Preferably, the fixing component is a bolt assembly including a bolt and a nut;

the bolt is inserted into the sliding hole and passes through the first connecting rod to connect with the nut.

Preferably, the standing bracket fixing portion includes a first sliding groove, the standing bracket sliding portion is provided with a sliding rail for slidably fitting with the first sliding groove.

Preferably, a stop member is provided on a front end portion of the sliding rail which is inserted into the first sliding groove, a locking member is provided in an opening portion of the first sliding groove adapted for receiving the sliding rail.

Preferably, the mounting bracket is further includes a slidably connecting component provided inside the first sliding groove and slidably connected to the sliding rail.

Preferably, the slidably connecting component includes balls and a ball limiting portion, the ball limiting portion includes a second sliding groove for fitting with the sliding rail, a sliding groove wall of the second sliding groove includes a ball retaining groove in which the balls are placed, the sliding rail is inserted into the second groove and abuts against the balls.

The mounting bracket for air conditioner according to the present disclosure includes the supporting bottom bracket, the mounting standing bracket and the connecting rod, the supporting bottom bracket is hinged with the standing bracket fixing portion, and the mounting standing bracket includes the standing bracket sliding portion. Due to the hinged connection between the mounting standing bracket and the supporting bottom bracket, the mounting standing bracket may be disposed vertically to the supporting bottom bracket. The supporting bottom bracket is adapted to support the air conditioner, and the mounting standing bracket designed as a frame structure may enclose the air conditioner and hold the air conditioner tightly therein via the standing bracket sliding portion when the air conditioner is placed on the supporting bottom bracket.

In addition, in a preferred embodiment of the present disclosure, the connecting rod is adapted to connect the supporting bottom bracket and the mounting standing bracket. When the air conditioner is mounted in the mounting bracket of the present disclosure, the mounting bracket of the present disclosure may be more stable integrally by fastening the connecting rod. The mounting bracket for air conditioner according to the present disclosure may not only support the air conditioner, but also mount the air conditioner stably in the bracket, and then the mounting of the window air conditioner may be finished just by setting the bracket onto the windowsill.

### BRIEF DESCRIPTION OF DRAWINGS

FIG. 1 is a schematic view of the structure of a mounting bracket for air conditioner in an embodiment of the present disclosure;

FIG. 2 is an exploded view of the mounting bracket for air conditioner in an embodiment of the present disclosure;

FIG. 3 is a schematic view of the structure of a supporting bottom bracket in an embodiment of the present disclosure;

FIG. 4 is a schematic view of the structure of a standing bracket fixing portion in an embodiment of the present disclosure;

FIG. 5 is a schematic view of the structure of a standing bracket sliding portion in an embodiment of the present disclosure;

FIG. 6 is a schematic view of the structure of a first connecting rod in an embodiment of the present disclosure;

FIG. 7 is a schematic view of the structure of a second connecting rod in an embodiment of the present disclosure;

FIG. 8 is a schematic view of the structure of a stop member in an embodiment of the present disclosure;

FIG. 9 is a schematic view of the structure of a locking member in an embodiment of the present disclosure; and

FIG. 10 is a schematic view of the structure of a ball limiting portion in an embodiment of the present disclosure.

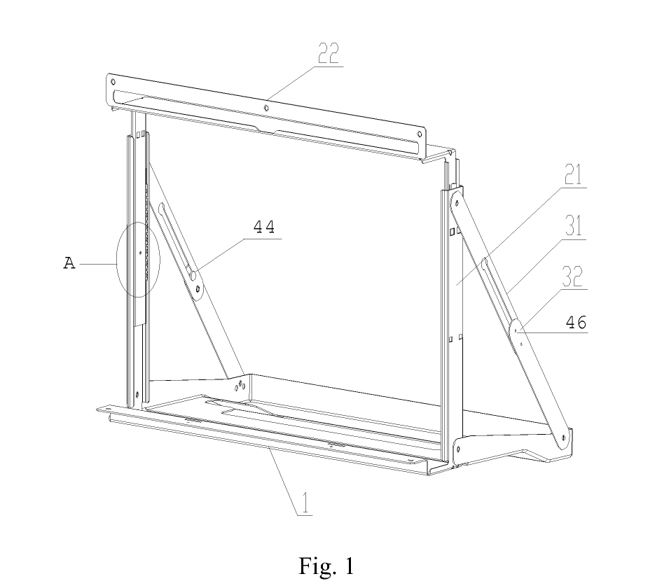

The corresponding relationships between the component and the reference numerals in FIGS. 1-10 are as follows:

a supporting bottom bracket 1; a mounting standing bracket 2; a standing bracket fixing portion 21; a first sliding groove 21a; a standing bracket sliding portion 22; a sliding rail 221; a connecting rod 3; a first connecting rod 31; a sliding hole 31a; a second connecting rod 32; a stop member 4; a locking member 5; a slidably connecting component 6; a ball 61 and a ball limiting portion 62.

### DETAILED DESCRIPTION OF THE INVENTION

The spirit of the present disclosure is to provide a mounting bracket for air conditioner which can not only support the window air conditioner but also install and fix the window air conditioner.

For better understanding of the technical solution of the present disclosure for the person skilled in the art, the present disclosure will be further described in detail in conjunction with drawings and embodiments as follows.

The mounting bracket for air conditioner according to the present disclosure is an assembly for mounting the window air conditioner. Due to adoption of an integrated structure, the window air conditioner needs to be mounted on a window with one end thereof placing outdoors and the other end thereof placing indoors so as to achieve heat exchange between the indoor environment and the outdoor environment.

Although, at present, some of the window air conditioners on sale in the market are provided with an air conditioner bracket, this kind of air conditioner bracket can only support the window air conditioner. Therefore, for some window air conditioners with small size, when a user places the window air conditioner on the window, he or she usually does not use the mounting bracket, but just places the air conditioner directly on the windowsill. By placing the air conditioner directly on the windowsill may cause a lot of inconveniences to the user when the user opens the window, and due to the body of the window air conditioner is not fixed by a fixing device, the risk that the air conditioner falling off from the windowsill is highly increased.

Thus, the present disclosure provides a mounting bracket for air conditioner for supporting and fixedly mounting the air conditioner.

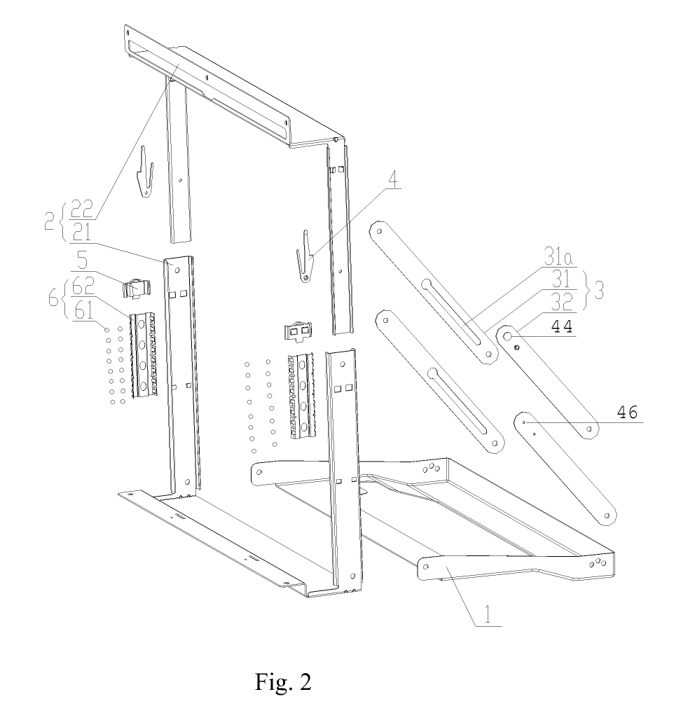

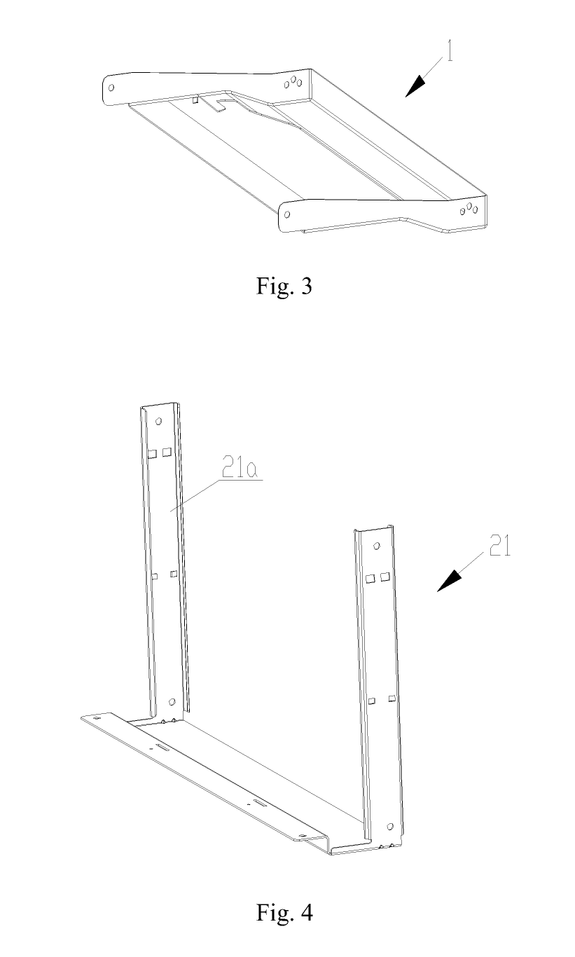

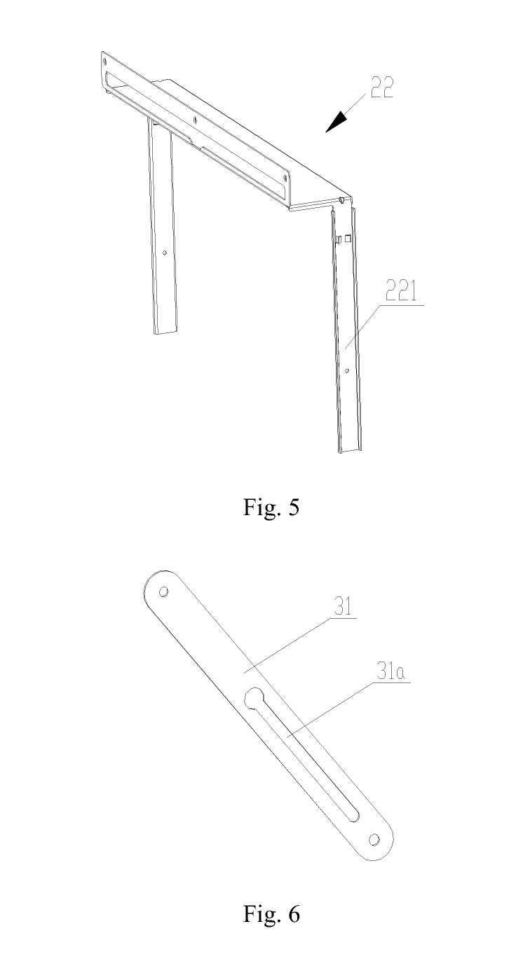

Referring to FIGS. 1-5, FIG. 1 is a schematic view of the structure of the mounting bracket for air conditioner in an embodiment of the present disclosure; FIG. 2 is a exploded view of the mounting bracket for air conditioner in an embodiment of the present disclosure; FIG. 3 is a schematic view of the structure of a supporting bottom bracket in an embodiment of the present disclosure; FIG. 4 is a schematic view of the structure of a standing bracket fixing portion in an embodiment of the present disclosure; FIG. 5 is a schematic view of the structure of a standing bracket sliding portion in an embodiment of the present disclosure.

The present disclosure provides the mounting bracket for air conditioner for mounting and fixedly supporting the window air conditioner, including a supporting bottom bracket 1; a mounting standing bracket 2 and a connecting rod 3.

Referring to FIGS. 3 and 4, the mounting standing bracket 2 includes a standing bracket fixing portion 21 and a standing bracket sliding portion 22 which are slidably connected with each other to form a frame structure for holding the window air conditioner. The body of the window air conditioners on sale usually is of a rectangular parallelepiped structure. Therefore, when lifting the standing bracket sliding portion 22, the frame of the frame structure may become bigger so as to insert the air conditioner in the frame of the mounting standing bracket 2 conveniently. Then by lowering the standing bracket sliding portion 22, the window air conditioner may be held in the mounting standing bracket 2. This structural design may not only limit the horizontal slide of the window air conditioner, but also avoid the window air conditioner being overturned laterally. Further the standing bracket sliding portion 22 may be adjusted so as to be adapted to the mounting of the window air conditioner with various heights.

As shown in FIG. 3, in one embodiment, the supporting bottom bracket 1 is designed as a rectangle, and the rectangular bottom bracket may provide even supporting force for most of the rectangular parallelepiped air conditioners such that the air conditioner may be placed stably under the even force.

The supporting bottom bracket 1 is hinged with the standing bracket fixing portion 21 which may rotate around a hinge point. With this structure, the mounting bracket of the present disclosure may be folded to be carried and transported conveniently when it is not in a working state.

The connecting rod 3 in the present disclosure may be a telescopic rod with one end thereof connecting to the standing bracket fixing portion 21 and the other end thereof connecting to the supporting bottom bracket 1. In the process of mounting the air conditioner, after a mounting angle between the supporting bottom bracket 1 and the standing bracket fixing portion 21 is adjusted, the connecting rod 3 is adapted to fix the supporting bottom bracket 1 and the standing bracket fixing portion 21 so as to stop the rotation therebetween. A triangular bracket structure is formed by the connecting rod 3, the supporting bottom bracket 1 and the standing bracket fixing portion 21, which can improve the stability of the frame structure.

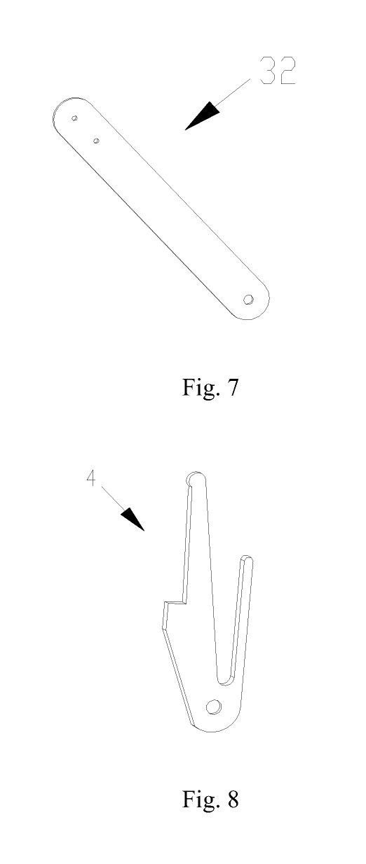

Referring to FIGS. 6 and 7, FIG. 6 is a schematic view of the structure of a first connecting rod in an embodiment of the present disclosure; FIG. 7 is a schematic view of the structure of a second connecting rod in an embodiment of the present disclosure.

The supporting bottom bracket 1 is hinged with the standing bracket fixing portion 21, the angle therebetween may be adjusted according to various window air conditioner, thus the connecting rod 3 connected between the supporting bottom bracket 1 and the standing bracket fixing portion 21 may employs the telescopic rod for adapting to various angles. In detail, in one embodiment of the present disclosure, the connecting rod 3 employs a two-stage telescopic rod. The two-stage telescopic rod 3 includes a first connecting rod 31 and a second connecting rod 32 which are slidably connected with each other to adapt to the various angles between the supporting bottom bracket 1 and the standing bracket fixing portion 21.

When the air conditioner is mounted in the mounting bracket of the present disclosure and the mounting bracket is adjusted, the air conditioner may be installed stably just by fixing the mounting bracket for air conditioner on the window. In addition, when the air conditioner needs to be detached, the air conditioner may be just removed from the mounting bracket for air conditioner, which simplifies the mounting and the detaching operations of the air conditioner.

As shown in FIG. 6, a sliding hole 31a is provided in a rod body of the first connecting rod 31 along the lengthwise direction thereof such that the second connecting rod 32 may slide relative to the first connecting rod 31, and the second connecting rod 32 may slide along the sliding hole 31a. A fixing component is provided on the second connecting rod 32 for slidably fitting with the sliding hole 31a. The fixing component is adapted to fix the first connecting rod 31 and the second connecting rod 32 after the length between the first connecting rod 31 and the second connecting rod 32 is adjusted.

In detail, the fixing component is a bolt. A screw hole is provided in one end of the second connecting rod 32. The bolt may pass through the sliding hole 31a to threadedly connect to the screw hole. With this structure, a force is exerted on the first connecting rod 31 by the bolt so as to fix the first connecting rod 31 and the second connecting rod 32.

Alternatively, the fixing may be achieved as follows. A bolt through hole is provided in one end of the second connecting rod 32, the fixing component employs a combination of a bolt and a nut, in which the bolt passes through the sliding hole 31a and the bolt through hole to connect to the nut. When a length of the connecting rod 3 needs to be adjusted, the nut is unfastened, and the bolt brings the second connecting rod 32 to slide in the sliding hole; when the length is adjusted appropriately, the nut is fastened so as to fix the first connecting rod 31 and the second connecting rod 32.

As shown in FIGS. 4 and 5, for realizing the sliding connection between the standing bracket fixing portion 21 and the standing bracket sliding portion 22, the standing bracket fixing portion 21 includes a first sliding groove 21a, and the standing bracket sliding portion 22 includes a sliding rail 221 slidably fit with the first sliding groove 21a. The mounting standing bracket 2 employs a frame structure, in detail, the standing bracket fixing portion 21 includes two fixing arms placed vertically, and the first sliding groove 21a is provided in each of the two fixing arms. The standing bracket sliding portion 22 includes two sliding arms fit with the two fixing arms of the standing bracket fixing portion 21. The cross-sectional shape of the sliding arm is modified to match with the first sliding groove 21a, and the sliding arm is inserted into the first sliding groove 21a as the sliding rail 221 such that the sliding connection between the standing bracket fixing portion 21 and the standing bracket sliding portion 22 is realized.

In addition, the sliding groove may also be provided on the standing bracket sliding portion 22, the sliding rail 221 may be provided on the standing bracket fixing portion 21.

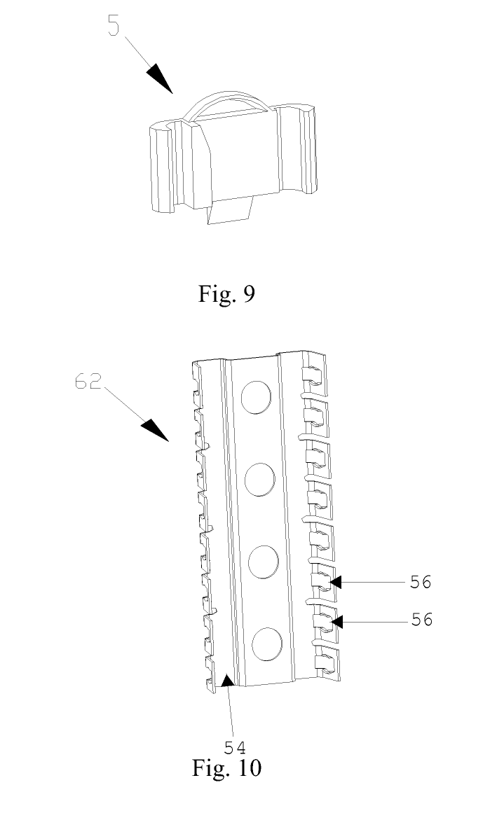

Referring to FIGS. 8 and 9, FIG. 8 is a schematic view of the structure of a stop member in an embodiment of the present disclosure; FIG. 9 is a schematic view of the structure of a locking member in an embodiment of the present disclosure.

A stop member 4 and a locking member 5 are provided in the mounting bracket of present disclosure such that the standing bracket fixing portion 21 and the standing bracket sliding portion 22 may be kept in a connected state when they are moved to a limiting position.

The locking member 5 is provided in a front end portion of the first sliding groove 21a, i.e. an opening portion, for inserting the sliding rail 221, of the first sliding groove 21a. The stop member 4 cooperates with the locking member 5 such that the standing bracket sliding portion 22 may not be pulled out when reaching the limiting position. The structure design of providing the locking member 5 in the front end portion of the first sliding groove 21a may ensure that the standing bracket sliding portion 22 has a relatively great sliding stroke.

The stop member 4 is provided in a front end portion of the sliding rail 221 which is inserted into the first sliding groove 21a. Owing to one elastic swing arm provided on edge of one side of the stop member 4, the sliding rail 221 may be stopped in the sliding groove.

For improving the sliding performance between the first sliding groove 21a and the sliding rail 221 and ensuring the durability of the mounting bracket of the present disclosure, it is further provided with a slidably connecting component 6 which is provided inside the first sliding groove 21a and slidably connected to the sliding rail 221.

Referring to FIG. 10 in conjunction with FIG. 2, FIG. 10 is a schematic view of the structure of a ball limiting portion in an embodiment of the present disclosure.

The slidably connecting component 6 according to the present disclosure includes balls 61 and a ball limiting portion 62. The ball limiting portion 62 includes a second sliding groove for fitting with the sliding rail 221. A sliding groove wall of the second sliding groove includes a ball retaining groove in which the balls 61 are placed. When the sliding rail 221 is inserted into the second sliding groove, the sliding rail 221 abuts against the balls 61. The rolling connection between the sliding rail 221 and the balls 61 may improve the sliding smoothness between the standing bracket fixing portion 21 and the standing bracket sliding portion 22. In addition, this structure may reduce the friction between the sliding groove and the sliding rail 221, and may improve the durability of the mounting bracket of the present disclosure.

The mounting bracket for air conditioner according to the present disclosure is an foldable bracket which may be unfolded by the user when the bracket is to be used, and may be adjusted and fastened according to the size of the air conditioner so as to receive the air conditioner into the bracket, thereby realizing the installation of the air conditioner. The mounting operation is simple.

The mounting bracket for air conditioner according to the present disclosure is described in detail hereinbefore. In the present description, specific examples are used to describe the principle and the embodiments of the present disclosure. The above description of the embodiments is only used for better understanding of the method and the spirit of the present disclosure. It should be noted that, for the person skilled in the art, any modifications and improvements may be made to the present disclosure without departing from the principle of the present disclosure, and these modifications and improvements are also deemed to fall into the protection scope of the present disclosure.

1. A mounting bracket for air conditioner for mounting and fixedly supporting a window air conditioner, comprising a supporting bottom bracket and a mounting standing bracket; wherein the mounting standing bracket comprises a standing bracket fixing portion and a standing bracket sliding portion which are slidably connected with each other to form a frame structure for the window air conditioner, and the supporting bottom bracket is connected to the standing bracket fixing portion.

2. The mounting bracket for air conditioner according to claim 1, further comprising a connecting rod which is a telescopic rod with one end thereof connecting to the standing bracket fixing portion and the other end thereof connecting to the supporting bottom bracket.

3. The mounting bracket for air conditioner according to claim 2, wherein the connecting rod is a two-stage telescopic rod comprising a first connecting rod and a second connecting rod which are slidably connected with each other.

4. The mounting bracket for air conditioner according to claim 3, wherein a sliding hole is provided in the first connecting rod along a lengthwise direction thereof, and a fixing component for slidably fitting with the sliding hole is provided on the second connecting rod.

5. The mounting bracket for air conditioner according to claim 4, wherein the fixing component is a bolt, a screw hole is provided in the second connecting rod, the bolt passes through the sliding hole to threadedly connect to the screw hole.

6. The mounting bracket for air conditioner according to claim 1, wherein the standing bracket fixing portion comprises a first sliding groove, a sliding rail for slidably fitting with the first sliding groove is provided on the standing bracket sliding portion.

7. The mounting bracket for air conditioner according to claim 6, wherein a stop member is provided on a front end portion of the sliding rail which is inserted into the first sliding groove, a locking member is provided in an opening portion of the first sliding groove adapted for receiving the sliding rail.

8. The mounting bracket for air conditioner according to claim 1, further comprises a slidably connecting component provided inside the first sliding groove and slidably connected to the sliding rail.

9. The mounting bracket for air conditioner according to claim 8 wherein the slidably connecting component comprises balls and a ball limiting portion, the ball limiting portion comprises a second sliding groove for fitting with the sliding rail, a sliding groove wall of the second sliding groove comprises a ball retaining groove in which the balls are placed, the sliding rail is inserted into the second groove and abuts against the balls.

10. The mounting bracket for air conditioner according to claim 1, wherein the supporting bottom bracket is directly connected to the standing bracket fixing portion.
